(19) United States
(12) Patent Application Publication
(10) Pub. No.: US 2007/0077349 A1
(43) Pub. Date: Apr. 5, 2007

(54) Patterning OLED device electrodes and optical material

(75) Inventors: David A. Newman, Honeoye Falls, NY (US); Timothy J. Tredwell, Fairport, NY (US); Ronald S. Cok, Rochester, NY (US); Zhihao Yang, Webster, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/241,370

(22) Filed: Sep. 30, 2005

(51) Int. Cl. B05D 5/12; B29C 71/02

(52) U.S. Cl. 427/66; 427/532; 427/256

(57) ABSTRACT

A method of making an OLED display having a plurality of OLED devices includes providing a plurality of OLED devices on a substrate, such OLED devices sharing a common light-transmissive electrode; forming a patterned conductive layer structure over the common light-transmissive electrode to define wells in alignment with emissive areas of one or more OLED devices; and providing optical material into one or more wells

### CROSS REFERENCE TO RELATED APPLICATIONS

Reference is made to commonly assigned U.S. patent application Ser. No. 10/944,586 filed Sep. 17, 2004, entitled “Method of Forming a Structured Surface Using Ablatable Radiation Sensitive Material”, by M. Zaki Ali et al, U.S. patent application Ser. No. 11/065,082 filed Feb. 24, 2005, entitled “OLED Device Having Improved Light Output” by Ronald S. Cok et al, U.S. patent application Ser. No. 11/095,166 filed Mar. 31, 2005, entitled “Reducing Angular Dependency in Microcavity Color OLEDS” by Amal P. Ghosh et al, U.S. patent application Ser. No. 11/130,772, filed May 17, 2005, entitled “Forming a Patterned Metal Layer Using Laser Induced Thermal Transfer Method” by Kelvin Nguyen et al and U.S. patent application Ser. No. ______ filed concurrently herewith, entitled “Laser Resist Transfer for Microfabrication of Electronic Devices” by Timothy Tredwell et al the disclosures of which are incorporated herein by reference.

### FIELD OF THE INVENTION

The present invention relates to organic light emitting diode (OLED) displays having a plurality of pixels, and more particularly, to displays that include an auxiliary electrode for improving the conductivity of a transparent continuous electrode in the display and for providing a structure for an optical material.

### BACKGROUND OF THE INVENTION

Flat-panel displays, such as organic light emitting diode (OLED) displays, of various sizes are proposed for use in many computing and communication applications. In its simplest form, an OLED includes an anode for hole injection, a cathode for electron injection, and an organic medium sandwiched between these electrodes to support charge recombination that yields emission of light. OLED displays can be constructed to emit light through a transparent substrate (commonly referred to as a bottom emitting display), or through a transparent top electrode on the top of the display (commonly referred to as a top emitting display).

Full color OLED displays are also known in the art. Typical full color OLED displays are constructed of three different color pixels that are red, green, and blue in color. Such an arrangement is known as an RGB design. An example of an RGB design is disclosed in U.S. Pat. No. 6,281,634. One of the main challenges of manufacturing full color OLED displays is the patterning of organic emissive materials. Precision shadow mask technology is most commonly used today in manufacturing. Although shadow mask deposition of OLED materials can work on a substrate of moderate size, e.g., 300 mm×400 mm, it becomes difficult with larger substrates or when the pixel density becomes very high such as can be achieved in top-emitting OLEDs. One problem is the handling (fabrication, alignment, etc.) of such large, thin, and fragile shadow masks. Another problem is the thermal coefficient of expansion mismatch between the shadow mask through which the OLEDs are to be deposited and the underlying substrate. This leads to misalignment of the mask and the proper deposition area on the substrate.

To solve the problems of shadow masks, it has been proposed to use a white light-emitting OLED with color filters. Each pixel is coupled with a color filter element as part of a color filter array (CFA) to achieve a pixilated multicolor display. The white light-emitting organic EL layers are typically formed common to all pixels and the final color as perceived by the viewer is dictated by that pixel's corresponding color filter element. Therefore a multicolor or full-color RGB display can be produced without requiring any patterning of the organic EL layers. An example of a white CFA top-emitting display is shown in U.S. Pat. No. 6,392,340.

The use of white OLED plus CFA technology is particularly useful in a large top-emitting active matrix OLED format. In bottom-emitting active matrix devices, the OLED pixels must be provided between opaque circuitry elements, thus limiting the pixel size (aperture). In the case of some amorphous-Si-based designs, bottom-emitting formats can be very difficult to construct. With top-emitting OLEDs, the TFT circuitry can be provided beneath the OLED, thus allowing large pixel apertures and high pixel density. However, as mentioned, the use of shadow masks for patterning high pixel density features becomes prohibitive due to insufficient manufacturing tolerances.

Further, the introduction of a CFA into top emitting-designs presents new challenges. A CFA can be provided on a separate substrate, but it then needs to be fabricated to match the OLED design, precisely aligned to the OLED and bonded to the OLED substrate. Due to the topography of a typical OLED device, a gap can be introduced between the OLED and the CFA, which can in certain circumstances result in unwanted optical effects and efficiency losses.

Another challenge to top emitting OLED devices is that a transmissive top electrode is typically provided as a common electrode for many or all pixels. Unfortunately, the most effective transmissive electrode materials, e.g., ITO and other metal oxides, have insufficient conductivity across the substrate, especially for large substrates. One way to solve this problem is to introduce a highly conductive auxiliary electrode or bus. Numerous bussing designs have been proposed, e.g., in U.S. Published Patent Application Nos. 2004/0253756; 2002/0011783 and 2002/0158835, but such designs add additional complexity to the manufacturing process.

OLED devices in general suffer from a loss of light trapped in various layers of the OLED, substrate, or cover, thereby decreasing the efficiency of the OLED device. Because light is emitted in all directions from the internal layers of the OLED, some of the light is emitted directly from the device, while some is emitted into the device and either absorbed or reflected back out. Some of the light is emitted laterally and trapped and absorbed by the various layers comprising the device. Light generated from an OLED device can be emitted through a top transparent electrode such as ITO, but it has been estimated that only about 20% of the generated light is actually emitted from such a device. The remaining light is trapped by internal reflections between layers and eventually absorbed.

Scattering techniques are known to improve the efficiency of light emission from an OLED device. Chou (International Publication Number WO 02/37580 A1) and Liu et al. (U.S. Patent Application Publication No. 2001/0026124 A1) taught the use of a volume or surface scattering layer to improve light extraction. The scattering layer is applied next to the organic layers or on the outside surface of the glass substrate and has an optical index that matches these layers. Light produced within the OLED device at higher than critical angle, which would have otherwise been trapped, can penetrate the scattering layer and be scattered out of the device. The efficiency of the OLED device is thereby improved. However, trapped light can propagate a considerable distance horizontally through the cover, substrate, or organic layers before being scattered out of the device, thereby reducing the sharpness of the device in pixelated applications such as displays. Scattering techniques cause light to pass through the light-absorbing material layers multiple times where they can be absorbed and converted to heat.

Therefore, a need exists to provide more effective way to employ optical materials, such as color filter and light scattering materials, and auxiliary electrodes in OLED display formats.

### SUMMARY OF THE INVENTION

It is therefore an object of the present invention to provide an OLED display including intrinsic optical material such as color filter or light-scattering material, such display having good electrical conductivity across its light-transmissive electrode(s).

This object is achieved by a method of making an OLED display having a plurality of OLED devices comprising:

(a) providing a plurality of OLED devices on a substrate, such OLED devices sharing a common light-transmissive electrode;

(b) forming a patterned conductive layer structure over the common light-transmissive electrode to define wells in alignment with emissive areas of one or more OLED devices; and

(c) providing optical material into one or more wells

The present invention provides a simple way to manufacture a top-emitting OLED having both patterned optical materials and a light-transmissive top electrode with improved electrical conductivity.

In another aspect, the present invention provides a simple way to manufacture a top-emitting OLED having improved contrast, and therefore improved usability under bright ambient conditions.

In still another aspect, the present invention provides a simple way to manufacture a top-emitting OLED having improved light emission efficiency, thereby improving overall efficiency.

### BRIEF DESCRIPTION OF THE DRAWINGS

FIG. 1 shows a top view of one embodiment of an OLED display with a plurality of OLED devices prepared according to the method of this invention;

FIG. 2 shows a cross-sectional view of the above OLED display;

FIG. 3 shows a top view of another embodiment of an OLED display with a plurality of OLED devices prepared according to the method of this invention;

FIG. 4 shows a block diagram of one embodiment of a method for making an OLED display according to this invention;

FIG. 5 shows a block diagram of another embodiment of a method for making an OLED display according to this invention; and

FIG. 6 shows a cross-sectional view of one embodiment of an OLED display with a plurality of OLED devices prepared according to the method of this invention.

Since device feature dimensions such as layer thicknesses are frequently in sub-micrometer ranges, the drawings are scaled for ease of visualization rather than dimensional accuracy.

### DETAILED DESCRIPTION OF THE INVENTION

The term “OLED display” or “organic light-emitting display” is used in its art-recognized meaning of a display device comprising organic light-emitting diodes as pixels. A color OLED display emits light of at least one color. The term “multicolor” is employed to describe a display panel that is capable of emitting light of a different hue in different areas. In particular, it is employed to describe a display panel that is capable of displaying images of different colors. These areas are not necessarily contiguous. The term “full color” is employed to describe multicolor display panels that are capable of emitting in several regions of the visible spectrum and therefore displaying images in a large combination of hues. The red, green, and blue colors constitute the three primary colors from which all other colors can be generated by appropriate mixing. However, for this invention, full-color can include additional different color pixels. The term “hue” refers to the intensity profile of light emission within the visible spectrum, with different hues exhibiting visually discernible differences in color. The term “pixel” is employed in its art-recognized usage to designate an area of a display panel that can be stimulated to emit light independently of other areas. However, it is recognized that in full-color systems, several pixels of different colors will be used together to generate a broad range of colors, and a viewer may term such a group a single pixel. For example, in a three-color RGB full-color display, a group of pixels generally includes three primary-color pixels, namely red, green, and blue (RGB), which are color-gamut-defining pixels. For the purposes of this invention, the term “OLED device” will also be used to refer to a pixel.

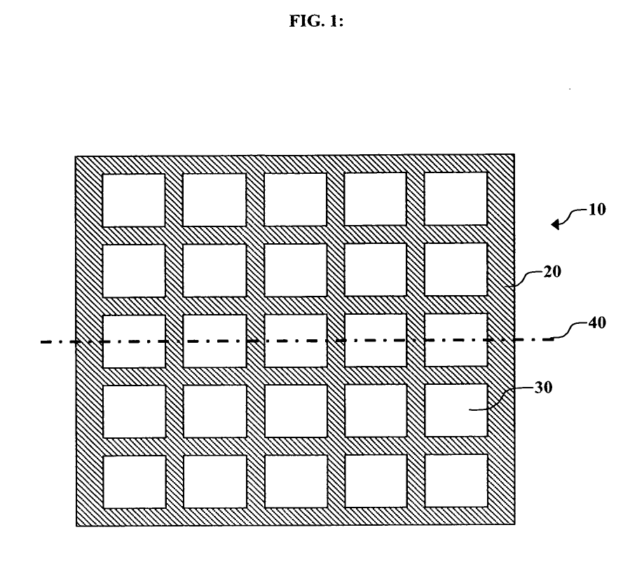

Turning now to FIG. 1, there is shown a top view of one embodiment of an OLED display with a plurality of OLED devices prepared according to the method of this invention. OLED display 10 includes a plurality of OLED devices 30. Each OLED device 30 is a pixel, that is, an individually addressable light-emitting unit of OLED display 10. OLED display 10 also includes a patterned conductive layer structure 20, whose nature will become clear. Patterned conductive layer structure 20 is patterned as a grid to cover the inter-OLED device areas—that is, the non-light-emitting areas—of OLED display 10 and to not cover the emissive areas of OLED devices 30. Other arrangements, such as delta patterns, can also be used. Patterned conductive layer structure 20 can be precisely aligned with OLED devices 30 as shown in FIG. 1, or can be less precisely aligned. Patterned conductive layer structure 20 can also be wider than the gaps between adjacent OLED devices 30 to accommodate the less-precise alignment.

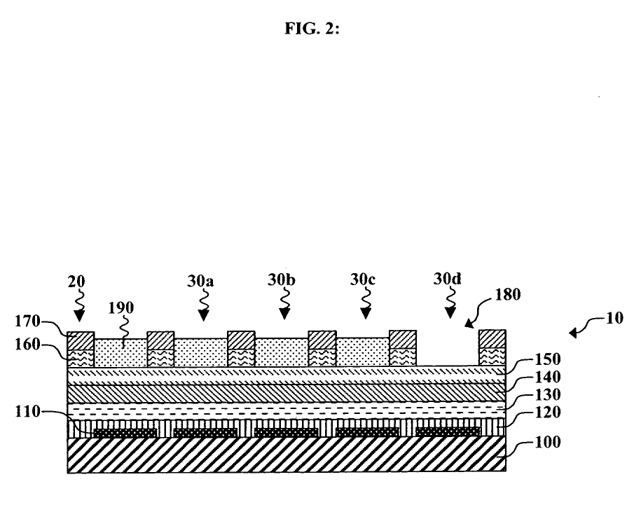

Turning now to FIG. 2, there is shown a cross-sectional view of the OLED display of FIG. 1 along cross-section line 40. OLED display 10 is formed over substrate 100 and provides a plurality of OLED devices, e.g. 30a, 30b, 30c, and 30d. A series of bottom electrodes 110 is formed over substrate 100 in a pattern that defines the OLED devices of OLED display 10. The OLED devices can be different color pixels, e.g. red, green, and blue light-emitting pixels. Some embodiments can also include white light-emitting pixels. The OLED devices of OLED display 10 share a common light-transmissive electrode 150. Such an arrangement commonly occurs in an active-matrix display, wherein one electrode to each OLED device is individually addressable, while the second electrode is shared by many or all OLED devices. Each pixel is controlled independently with, for example, thin film transistors (TFTs). Such TFTs can be constructed using amorphous silicon, low temperature polycrystalline silicon, single crystal silicon, other inorganic semiconductors, or organic semiconductor materials. The bottom electrodes 110 are most commonly configured as anodes, and common light-transmissive electrode 150, which is the top electrode, is most commonly configured as the cathode. However, the practice of this invention is not limited to this configuration.

OLED display 10 includes a light-emitting layer 130 between bottom electrodes 110 and common light-transmissive electrode 150. OLED display 10 can also optionally include other layers, such as hole-transporting layer 120 and electron-transporting layer 140, as well as layers such as hole-injecting layers, electron-injecting layers, and other layers known in the art.

Patterned conductive layer structure 20 is formed over common light-transmissive electrode 150 and is more conductive than common light-transmissive electrode 150. Patterned conductive layer structure 20 includes at least a patterned conductive layer 160 in contact with common light-transmissive electrode 150, and preferably further includes a patterned insulating layer 170 disposed over patterned conductive layer 160. Patterned conductive layer 160 conducts current, thereby reducing the sheet resistivity of common light-transmissive electrode 150 across the display and reducing the resistive heating and voltage drop. Patterned conductive layer 160 can be a metal that is a good conductor, including but not limited to aluminum, copper, magnesium, molybdenum, silver, titanium, gold, tungsten, nickel, chromium, or alloys thereof. Patterned conductive layer 160 can include a bilayer structure of two different metals or a metal and a semiconductor or conductive polymer.

Patterned insulating layer 170 can be organic, inorganic, or an inorganic/organic composite. Patterned insulating layer 170 can include almost any patternable organic polymer including, but not limited to cyanoacrylates, polyimides, methacrylates, or nitrocellulose. Photoresist polymeric materials are particularly useful. Non-limiting examples of inorganic materials for patterned insulating layer 170 include insulating metal oxides, such as those formed from sol-gel solutions or formed by evaporative deposition. Patterned insulating layer 170 should be selected so as not to degrade OLED performance, e.g., by outgassing harmful materials, corroding the patterned conductive layer, contaminating the OLED via processing steps, etc.

Patterned conductive layer structure 20 defines wells 180, which are in alignment with the emissive areas of the OLED devices, that is, in alignment with bottom electrodes 110. Wells 180 can function to contain material, and optical material 190 can be provided into one or more wells. Optical material 190 can include, e.g. a colorant for forming a color filter, a color conversion material, a light-scattering material, or a lenslet. A color filter is a material that absorbs radiation of certain frequencies (e.g. by using a light absorbing dye or pigment) but transmits radiation of other frequencies, thereby altering (filtering) the spectrum. A color conversion material absorbs radiation of one frequency and re-emits radiation of another frequency. A light-scattering material redirects a substantial portion of the light that strikes the light-scattering material. A lenslet focuses light that passes through it. More than one optical material can be provided in one or more wells. If optical material 190 is a colorant or a color conversion material, different wells 180 are deposited with different colorants or color conversion materials to provide a color filter array or a color conversion material array. For example, some wells are provided with a red colorant (e.g. OLED device 30a), some with a green colorant (e.g. OLED device 30b), and some with a blue colorant (e.g. OLED device 30c), such that a light-emitting layer 130 that emits white light can be used to form a full-color OLED display. In this case, it is helpful if the wells 180 have a height large enough to prevent the colorant from filling the well 180 and preventing the diffusion of colorants between wells 180. For example, a well height of 0.5 microns can be suitable for containing one optical material if other protective materials do not form a thick covering over the wells 180. If protective layers are formed over the wells 180, or a plurality of optical materials are provided in one or more of the wells 180 in one or more deposition steps, it can be useful to have much deeper wells, for example 5 microns deep or even more. Alternatively, relatively deep wells are useful if a relatively large volume of optical materials are needed. Relatively deep wells are also useful for providing an improved ambient contrast ratio. The present invention is used to construct RGBW displays having red, green, blue, and white light-emitting pixels. This can be constructed using a common white light-emitting layer as described above, but in this case, the white pixel does not necessarily need optical material 190 in association with it (e.g. OLED device 30d). However, if needed, the white pixel can include an optical material, e.g., for trimming the white hue. RGBW displays are disclosed in U.S. Patent Application Publication No. 2004/0113875 A1.

Optical material 190 can be deposited into the wells 180 in many ways. When patterning is required, such as for providing color filters or color conversion media, the optical material can be provided into wells 180 by ink jet deposition, but other means such as patterned laser transfer or screen-printing can also be useful. The formation of color filter arrays by ink jet deposition has been described, for example, in U.S. Pat. Nos. 6,909,477; 6,874,883, U.S. Patent Application Publication Nos. 2005/0100660 A1 and 2002/0128351 A1. When patterning is not required, such as when all the wells 180 are to be filled by the same optical material, curtain coating, spin coating, drop coating, spray coating and other related methods can be used. For example, light-scattering materials can be deposited this way and most of such material will flow into the wells 180. However, ink jet and other methods are still useful even when all the wells 180 have the same optical material 190.

Patterned conductive layer structure 20 can optionally act as a black matrix to absorb light to increase the contrast of OLED display 10. Brightness and/or lifetime of the OLED display device can be increased. The sharpness of the display can also be improved because unwanted, emitted light that might otherwise be internally reflected within the layers of the display device can be absorbed by the light-absorbing material. In one embodiment, the light absorbing material forms patterned conductive layer 160, e.g. a black silver compound. Silver is a highly thermally and electrically conductive material and can be made light absorbing through electro-chemical processes known in the art; for example, it can be oxidized and reduced. The deposition and patterning process for the light-absorbing patterned conductive layer 160 is done through the use of conventional photo-resistive processes. Silver compounds are suggested in the prior art as candidates for electrodes, for example magnesium silver compounds. Other suitable materials include aluminum, copper, magnesium, titanium, or alloys thereof.

In a particularly useful embodiment, the patterned conductive layer 160 can include metal nanoparticles deposited in the desired pattern by laser transfer from a donor, as described above-cited commonly assigned U.S. patent application Ser. No. 11/130,772. In this method, relatively thick layers of the patterned conductive layer 160 can be prepared. For example, metal nanoparticles having a particle size of 2-4 nm can prepared and mixed with an IR-absorbing dye in an organic solution, and then uniformly coated onto a donor sheet and dried. The thickness of the dried metal nanoparticle layer can be very thin or up to 2 um or more. The donor sheet can be placed adjacent (preferably in contact) to the common light transmissive electrode 150. By patterned radiation, preferably by laser radiation, the IR dye absorbs radiation to produce heat which causes annealing of the metal nanoparticles. When the donor sheet is removed, the annealed metal nanoparticles remain on the light transmissive electrode 150.

In another embodiment, light-absorbing material can be part of patterned insulating layer 170. The light-absorbing material can include a metal oxide, metal sulfide, silicon oxide, silicon nitride, carbon, a light-absorbing polymer, a polymer doped with an absorbing dye, or combinations thereof. Preferably, the light-absorbing material is black and can include further anti-reflective coatings.

In a preferred embodiment, the conductive layer is uniformly deposited over the top transmissive electrode, e.g., by evaporation or sputtering. Next the patterned insulating layer 170 is provided over the conductive layer and used as an etch mask to pattern conductive layer 160 and the patterned insulation layer is not removed. Although polymer etch masks are typically removed, it is advantageous in the present invention to leave patterned insulating layer 170 for several reasons.

First, leaving the patterned insulating layer 170 reduces manufacturing steps.

Second, although one can use only conductive layer 160 to act as a well for optical materials, it can be difficult and time consuming to pattern such a conductive layer to sufficient thickness (although it should be noted that the method employing metal nanoparticles described above can overcome some of these deficiencies). Depending on the particular application, a thickness of one to several microns might be needed for the optical materials. This can cause long deposition times or etch times for the conductive material. In addition, thick metal layers can sometimes yield high stresses resulting in device failure, e.g. delamination in one or more layers of the OLED. In contrast, patterned insulating layer 170 is easily made having thicknesses of one to several microns, particularly if they are polymeric, and such polymer layers typically having less stress than metals of comparable thickness. Thus, it is generally preferred that the thickness of insulating layer 170 be greater than conductive layer 160.

Third, by using both a patterned conductive layer 160 and patterned insulating layer 170, the surface tension properties of each can be selected to more conveniently allow deposition of optical materials. For example, if the optical material is being deposited from a hydrophilic solvent, one can select or modify the surface tension of the patterned insulating layer 170 to be hydrophobic in order to repel the solvent. This can affect the shape of the deposited optical material.

For example, one can form lenslets this way. When the patterned insulating layer 170 acts as an etch mask and remains part of the structure, there are several ways to provide the patterned insulating layer 170. In one preferred method, the patterned insulating layer 170 is provided by transferring a polymer by radiation induced thermal transfer (e.g. laser transfer from a donor), such as described by Burberry et al. in U.S. Pat. No. 5,858,607, Toyoda et al. in U.S. Patent No. 2005/0074705, and above-cited commonly assigned U.S. patent application Ser. No. ______ filed concurrently herewith.

When using laser transfer patterning, the patterned insulating layer 170 can include a polymer binder, an amorphous organic solid, a thermally labile or gas-producing substance, and optionally a radiation-absorbing material. In addition, the insulating layer can contain dye or pigment colorants to form a black matrix.

The polymeric binders and organic solids useful in laser transfer of insulating layer 170 are preferably thermally labile or gas-producing substances such as polycyanoacrylate, nitrocellulose, copolymers of maleic anhydride, and materials disclosed in U.S. Pat. No. 6,190,827 to Weidner and U.S. Pat. No. 6,165,671 to Weidner et al. and references cited therein, as components of a propellant layer in laser donor elements. Insulating layer 170 can also contain other polymeric and organic solids necessary to ensure the physical integrity of the layer.

The radiation-absorbing material of insulating layer 170 can be a dye such as the dyes specified in commonly assigned U.S. Pat. No. 4,973,572 to DeBoer and U.S. Pat. No. 5,578,416 to Tutt, or a pigment such as carbon black. The main criterion is that radiation-absorbing material of insulating layer 170 absorb laser light, at the given wavelength, at a high enough intensity for transfer of material from the donor to the substrate. The efficiency of this transfer is well known to depend on the laser fluence, spot size, beam overlap and other factors.

The amorphous organic solids of insulating layer 170 can be monomeric resins as described in previously cited U.S. Pat. No. 6,165,671, such as hydrogenated and partially hydrogenated rosin esters and similar rosin esters. Commercially available materials include the glycerol ester of hydrogenated wood rosin, such as Staybellite Ester 10 (Hercules), the glycerol ester of hydrogenated rosin, such as Foral 85 (Hercules), and the pentaerythritol ester of modified rosin, such as Pentalyn 344 (Hercules). The amorphous organic solids of layer 170 can also include monomeric glassy solids as described in commonly assigned U.S. Pat. No. 5,891,602 to Neumann, as binder elements in a dye donor laser transfer sheet. The amorphous organic solids of insulating layer 170 can also be oligomeric resins with a molecular weight of less than about 4000, such as the polyester Tone 260.

In addition to the materials already disclosed, insulating layer 170 can include surface active agents necessary as coating aids and used for the modification of surface properties, hardeners, adhesion promoting agents, and the like, necessary for the physical integrity and manipulation of the manufactured devices. As mentioned, dyes and pigments can also be added to insulating layer 170 in order to form a black matrix.

Transfer can be by adhesion transfer, or more preferably, by ablation transfer. The term “ablative transfer” is broadly understood to be a heat-induced transfer from the donor medium, wherein at least a portion of a component of the donor medium is converted to a gaseous state. The material that is converted to gaseous state can be the resist (polymer) material itself or can be some other component material of the donor that thus serves as a propellant for ablative transfer. In either case, expansion to gaseous form creates a propellant force that acts as the transfer mechanism in ablative transfer. The broad classification of ablative transfer can include sublimation transfer in which some or all of the resist donor material that is heated is converted from a solid to a vapor. Ablative transfer also includes fragmentation transfer or particulate transfer, in which at least some portion of the donor material may not actually be converted to gaseous state, but is effectively fragmented and propelled by the conversion to vapor form of some heated component of the donor. In ablative transfer, the donor resist material is propelled across a gap between the surface of the donor and receiver substrate. The vaporization and gaseous flow mechanisms of ablative transfer differentiate this method from conventional adhesive transfer, which relies on intimate contact (that is, having no gap) and some type of melting that transfers the resist material between donor and receiver. In contrast, the ablative transfer technique requires a gap between the donor and receiver surfaces. The thermoresist material to be deposited, or some other material in the donor that serves as a propellant, is heated to a state of sublimation or ablation, causing partial or full vaporization of at least some component of the donor. Under suitable heating from a laser or other source, the resulting vapor and/or ablated solids travel across the gap, from the donor to the receiver surface, in a partially or fully vaporized form.

In another useful embodiment where the patterned insulating layer 170 remains and acts as a resist, a uniform insulating layer can be patterned by ablative removal, e.g., as disclosed in above cited commonly assigned U.S. patent application Ser. No. 10/944,586. In this case the insulating layer includes a radiation-sensitive ablatable material and is uniformly coated over the conductive layer. Such coating can be done by spin coating, curtain coating, spray coating, or other convenient methods. The insulating layer is then patterned by applying patterned radiation, e.g., from a laser, which causes material to ablate in radiation-exposed regions. The conductive layer can then be patterned by etching. The ablatable radiation-sensitive coating can include a variety of components. The components should be selected so that the ablatable radiation-sensitive coating is able to ablate from the substrate upon exposure to radiation. For example, in one embodiment the ablatable radiation-sensitive coating includes a binder and an infrared absorbing compound. In another embodiment, the ablatable radiation-sensitive coating includes a binder, an infrared absorbing compound, and a polymeric fluorocarbon that serves as a repelling material. In still another embodiment, the ablatable radiation-sensitive coating includes a binder and an ultraviolet absorbing compound. In yet another embodiment, the ablatable radiation-sensitive coating includes a binder, an infrared absorbing compound, and a wetting agent. Other embodiments can also be formed using suitable components. Binders having a high degree of hydroxy functionality, e.g., poly(vinyl alcohol), are particularly useful.

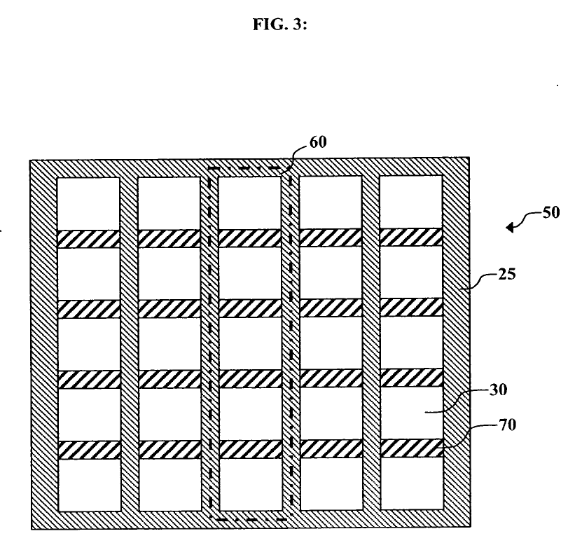

Turning now to FIG. 3, there is shown a top view of another embodiment of an OLED display with a plurality of OLED devices prepared according to the method of this invention. OLED display 10 includes a plurality of OLED devices 30. Each OLED device 30 is a pixel, that is, an individually addressable light-emitting unit of OLED display 10. OLED display 10 also includes a patterned conductive layer structure 25, which is similar to patterned conductive layer structure 20 of FIG. 1. In this case, however, patterned conductive layer structure 25 is patterned as a series of columns to cover the inter-OLED-device areas between columns of OLED devices 30 of OLED display 10, and to not cover OLED devices 30, nor inter-OLED-device areas between rows of OLED devices, e.g. inter-OLED-device area 70. This arrangement will define wells that are in alignment with a plurality of OLED devices on OLED display 50, e.g. well 60. Successive wells 60 can be of different colors, for example, repeated columns of red, green, and blue. Alternatively, the display can be laid out in rows.

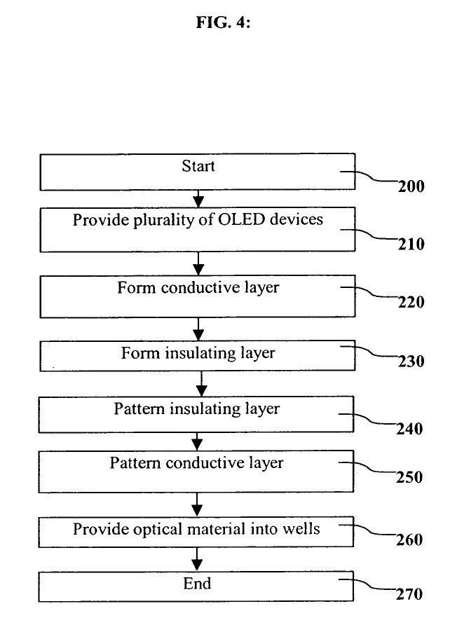

Turning now to FIG. 4, and referring also to FIG. 2, there is shown a block diagram of one embodiment of a method for making an OLED display according to this invention. At the start of the process (Step 200), an OLED display 10 with a plurality of OLED devices (e.g. 30a, 30b, etc.) is provided (Step 210). By this, it is meant a plurality of OLED devices including at least a substrate 100, bottom electrodes 110, a light-emitting layer 130, and a common light-transmissive electrode 150. Methods for preparing such OLED displays are well known in the art. A conductive layer as described above is then formed over the entire surface of common light-transmissive electrode 150 (Step 220). Such a layer can be formed by e.g. evaporative deposition or sputtering. An insulating layer as described above is then formed over the entire surface of the conductive layer (Step 230). The insulating layer can be deposited by evaporatively coating a solution of the polymer in a solvent such as methanol, acetone, tetrahydrofuran, or ethyl acetate. At this point, OLED display 10 includes a non-patterned conductive layer structure over common light-transmissive electrode 150.

The uniform insulating layer is then patterned (Step 240), providing a patterned insulating layer over the conductive layer. This can be done several ways, depending on the nature of the insulating layer. If the insulating layer is of a photosensitive nature, e.g. a photoresist, it can be exposed to radiation patternwise through a mask to polymerize portions of the coating. Portions of the material exposed to the radiation are cured and the remainder is washed away. Alternatively, a non-photosensitive insulating layer such as a cyanoacrylate or nitrocellulose layer can be removed in the emissive areas of the OLED devices by using laser ablation in a pattern, e.g. by an infrared laser of a wavelength that will be absorbed by the insulating layer. This step will pattern the uniform insulating layer to provide patterned insulating layer 170, expose the conductive layer over the emissive areas of the OLED devices, and form a portion of wells 180.

Uniform conductive layer is then patterned by removing it (Step 250) over the emissive areas of the OLED devices, such areas of the conductive layer having been exposed in the above step. That is, the patterned insulating layer is used as an etch mask to pattern the conductive layer to form the patterned conductive layer. This can be done several ways, depending on the nature of the conductive layer and of the underlying common light-transmissive electrode 150. A well-known light-transmissive electrode includes indium tin oxide (ITO). The conductive layer can be patterned by chemical etching, e.g. a silver conductive layer can be removed by treatment with a ferric nitrate solution. Alternatively, the conductive layer can be patterned by plasma etching, e.g. if the conductive layer is aluminum. Chlorine plasma etching of aluminum is well-known. A chlorine plasma can be generated by treating a chlorinated compound (e.g. CCl₄, CHCl₃, BCl₃, or even chlorine gas) with an electric discharge. This step will convert the uniform conductive layer into patterned conductive layer 160 and complete the process of forming patterned conductive layer structure 20, and of wells 180.

Optical material 190 is then provided into one or more of the wells (Step 260). For example, optical material 190 can be a color filter material or a series of color filter materials that is deposited into the different wells by ink jet deposition to provide a color filter array. The formation of color filter arrays by ink jet deposition has been described, for example, in US 2005/0100660 A1, U.S. Pat. No. 6,909,477 B1, U.S. Pat. No. 6,874,883 B1, and US 2002/0128351 A1.

Alternatively, as described above, optical material can be a color conversion material or series of color conversion materials, a light-scattering material, or a lenslet material, or combinations thereof. After optical material 190 is provided into wells 180, the process can end (Step 270), or further processing can take place (not shown), such as thermal annealing, application of barrier layers, providing a cover, etc.

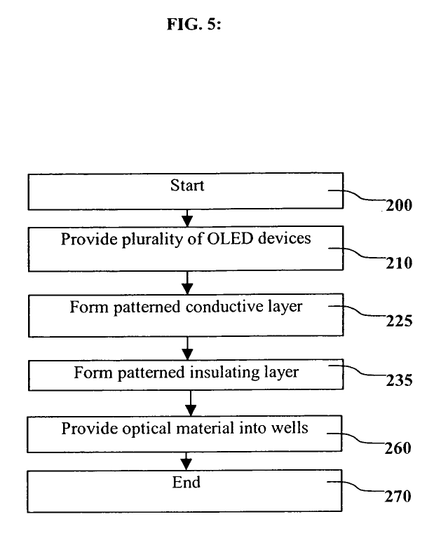

Turning now to FIG. 5, there is shown a block diagram of another embodiment of a method for making an OLED display according to this invention. This procedure is initially similar to that of FIG. 4 in that a plurality of OLED devices is provided on a substrate (Step 210). A patterned conductive layer 160 is formed over common light-transmissive electrode 150 (Step 225), for example by vapor deposition through a shadow mask, or by laser thermal transfer of a conductive material as described in above-cited commonly assigned U.S. Patent Application. Alternatively, the patterning of the conductive layer can be provided by well-known photolithographic processes. A patterned insulating layer 170 is then provided over patterned conductive layer 160 (Step 235). The patterning can be done by patterned thermal transfer of an insulating material from a donor sheet, for example, by coating an insulating material onto a donor substrate sheet, placing the donor substrate sheet in contact with or in close proximity to the OLED substrate, and selectively heating the donor with a laser to cause transfer of the insulating material to the OLED substrate. In another embodiment, patterned insulating layer 170 can be a thick film and can be deposited using screen printing methods. Alternatively, patterned insulating layer 170 can be deposited through a shadow mask that was also used to deposit patterned conductive layer 160. Optical material 190 is then provided as described above into wells 180 formed by patterned conductive layer structure 20, that is patterned conductive layer 160 and patterned insulating layer 170 (Step 260) and the process ends (Step 270), or further processing can be effected as described above.

A combination of the above techniques can be used. For example, the conductive layer can be provided as a uniform layer, as in FIG. 4, and the insulating layer then provided as a patterned layer as in FIG. 5, for example by laser transfer. The conductive layer can then be patterned by an etching method as in FIG. 4 to provide patterned conductive layer structure 20 and wells 180.

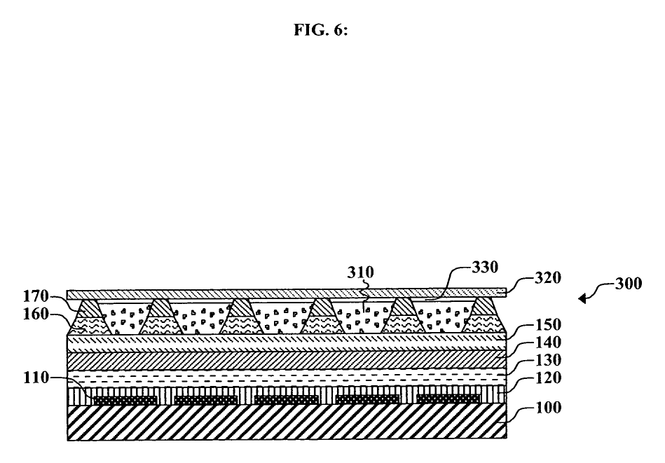

In one embodiment of this invention, the optical material can include particles forming a light scattering layer in the well that improves the efficiency of light emission from the OLED. Turning now to FIG. 6, there is shown an embodiment of an OLED display 300 of this invention incorporating a scattering layer. OLED display 300 also shows another embodiment of a patterned conductive layer structure, wherein patterned conductive layer 160 and patterned insulating layer 170 are tapered to form tapered wells. The optical material in the wells is light-scattering material 310. Light-scattering material 310 can include a volume scattering layer or a surface scattering layer. In certain embodiments light-scattering material 310 can include components having at least two different refractive indices. Light-scattering material 310 can include, e.g., a matrix of lower refractive index and scattering elements having a higher refractive index. Alternatively, the matrix can have a higher refractive index and the scattering elements can have a lower refractive index. For example, the matrix can include silicon dioxide or cross-linked resin having indices of approximately 1.5, or silicon nitride with a much higher index of refraction. If light-scattering material 310 has a thickness greater than one-tenth of the wavelength of the emitted light, then it is desirable for the index of refraction of at least one component of the light-scattering material to be approximately equal to or greater than the refractive index of the layer it contacts, that is common light-transmissive electrode 150 in this case. This is to insure that all of the light trapped in the electrode can experience the direction altering effects of the light-scattering material. If light-scattering material 310 has a thickness less than one-tenth part of the wavelength of the emitted light, then the materials in the scattering layer need not have such a preference for their refractive indices. In one embodiment, the matrix of lower refractive index has an optical refractive index matched to that of common light-transmissive electrode 150.

In an alternative embodiment, light-scattering material 310 can include particles deposited on another layer, e.g., particles of titanium dioxide can be coated over common light-transmissive electrode 150 to scatter light. Preferably, such particles are at least 100 nm in diameter to optimize the scattering of visible light. The light-scattering material is typically adjacent to, and in contact with, common light-transmissive electrode 150 to defeat total internal reflection in the organic layers and electrode. According to an embodiment of the present invention, the organic layers and electrodes combined can form a waveguide for some of the emitted light, since the organic layers have a refractive index lower than that of the transparent electrode and the bottom electrode is reflective. The light-scattering material disrupts the total internal reflection of light in the organic and transparent electrode layers and redirects some portion of the light out of the layers.

Light-scattering material 310 can include organic materials (for example polymers or electrically conductive polymers) or inorganic materials. The organic materials can include, e.g., one or more of polythiophene, PEDOT, PET, or PEN. The inorganic materials can include, e.g., one or more of SiOₓ (x>1), SiNₓ (x>1), Si₃N₄, TiO₂, MgO, ZnO, Al₂O₃, SnO₂, In₂O₃, MgF₂, and CaF₂. Light-scattering material 310 can include, for example, silicon oxides and silicon nitrides having a refractive index of 1.6 to 1.8 and doped with titanium dioxide having a refractive index of 2.5 to 3. Polymeric materials having refractive indices in the range of 1.4 to 1.6 can be employed having a dispersion of refractive elements of material with a higher refractive index, for example randomly located spheres of titanium dioxide can be employed in a matrix of polymeric material. Alternatively, a more structured arrangement employing indium-tin oxide, silicon oxides, or silicon nitrides can be used. Shapes of refractive elements can be cylindrical, rectangular, or spherical, but it is understood that the shape is not limited thereto. The difference in refractive indices between components of the light-scattering material can be, for example, from 0.3 to 3, and a large difference is generally desired. The thickness of the light-scattering material, or size of features in, or on the surface of, a scattering layer can be, for example, 0.03 to 50 μm. It is generally preferred to avoid diffractive effects in the light-scattering material. Such effects can be avoided, for example, by locating features randomly or by ensuring that the sizes or distribution of the refractive elements are not the same as the wavelength of the color of light emitted by the device from the light-emitting area.

It is known that particles of different sizes in a scattering layer can have different optical effects dependent on wavelength. Hence, in a further embodiment of the present invention, particles having different size distributions are deposited into different wells representing different colored pixels. In various alternative embodiments the particles and/or the matrix material itself can be colored and form a color filter in a single layer. For example, a resin or polymer can have colorants such as dyes or pigments. Pigment particles can also serve as a scattering material.

In an alternative embodiment, optical materials are formed in one or more layers to provide a variety of optical effects in the various layers. For example, a scattering layer can be formed over the transparent electrode within a well and another color filter layer formed over the scattering layer. Alternatively, the color filter layer can be located beneath the scattering layer. These layers can be formed in separate deposition steps using the same or different equipment for depositing the layers.

Other optical effects can be desired and employed in the optical materials. For example, neutral density filters can be formed by employing carbon black in a polymer matrix as an optical layer. In an alternative embodiment, separate layers of optical materials can have differing indices that, together, form an optical filter by employing constructive and deconstructive optical effects.

OLED display 300 further provides light-transmissive cover 320 over the display, which forms a gap 330 between light-scattering material 310 and light-transmissive cover 320. As is taught in above-cited, commonly assigned U.S. patent application Ser. No. 11/065,082 the sharpness of a display device can be reduced when a light-scattering material is employed unless a low-refractive-index layer is provided between the light-scattering material and a light-transmissive substrate or cover such as cover 320. In an embodiment of the present invention, such a low-refractive-index layer can be provided by employing the space in the well above the optical materials and below the top of the well, e.g. gap 330. In such an embodiment, gap 330 between the optical materials and the top of the well is filled with air, inert gas, or a material having an optical refractive index lower than that of the transparent substrate 100, light-transmissive cover 320, or common light-transmissive electrode 150, and having an optical refractive index lower than that of any organic materials in the light-emissive layer(s) of the OLED. Preferably, such a gap between the optical materials and the cover is at least 0.5 microns, and more preferably more than 1 micron, and even more preferably more than 5 microns.

The wells can be provided with reflective edges, for example if metal conductors are used for the patterned electrode, to assist with light emission for the light that is emitted toward the edges of each light-emitting area. Reflective coatings can be applied by evaporating thin metal layers. Alternatively, wells can be opaque or light absorbing. Light absorbing materials can employ, for example, color filters material known in the art. Preferably, the sides of the wells are reflective while the tops can be black and light absorbing. A light-absorbing surface or coating will absorb ambient light incident on the OLED device, thereby improving the contrast of the device. A useful height for the wells above the surface of the OLED is one micron or greater. An adhesive can be employed on encapsulating light-transmissive cover 320 or the wells to affix the encapsulating cover to the wells to provide additional mechanical strength.

In an alternative embodiment of the present invention, an environmentally protective layer (not shown) can be located over the transparent electrode either beneath or over the optical materials. For example, aluminum oxide or parylene can deposited over the transparent electrode and beneath the optical materials.

Some structural features useful for OLED displays of this invention are described below.

Substrate

The OLED display of this invention is typically provided over a supporting substrate 100 where either the cathode or anode can be in contact with the substrate. The substrate can have a simple or a complex structure with numerous layers, for example, a glass support with electronic elements such as TFT elements, planarizing layers, wiring layers, etc. The electrode in contact with the substrate is conveniently referred to as the bottom electrode. Conventionally, the bottom electrode is the anode, but this invention is not limited to that configuration. The substrate can either be light transmissive or opaque, depending on the intended direction of light emission. The light transmissive property is desirable for viewing the EL emission through the substrate. Transparent glass or plastic is commonly employed in such cases. For applications where the EL emission is viewed through the top electrode, the substrate can be light transmissive, light absorbing or light reflective. Substrates for use in this case include, but are not limited to, glass, plastic, semiconductor materials, silicon, ceramics, metals with an insulating layer, and circuit board materials. Of course it is necessary to provide in these device configurations a light-transmissive top electrode.

Anode

In the case where common light-transmissive electrode 150 is the anode, the anode should be transparent or substantially transparent to the emission of interest. Common transparent anode materials used in this invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode. For applications where EL emission is viewed only through the cathode electrode, in the case where bottom electrodes 110 are the anodes, the transmissive characteristics of anode are immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes. Optionally, anodes can be polished prior to application of other layers to reduce surface roughness so as to minimize shorts or enhance reflectivity.

Hole-Injecting Layer (HIL)

It is often useful to provide a hole-injecting layer between the anode and hole-transporting layer 120. The hole-injecting material can serve to improve the film formation property of subsequent organic layers and to facilitate injection of holes into the hole-transporting layer. Suitable materials for use in the hole-injecting layer include, but are not limited to, porphyrinic compounds as described in U.S. Pat. No. 4,720,432, plasma-deposited fluorocarbon polymers as described in U.S. Pat. Nos. 6,127,004; 6,208,075 and 6,208,077, some aromatic amines, for example, m-MTDATA (4,4′,4″-tris[(3-methylphenyl)phenylamino]triphenylamine), and inorganic oxides including vanadium oxide (VOx), molybdenum oxide (MoOx), and nickel oxide (NiOx). Alternative hole-injecting materials reportedly useful in organic EL devices are described in EP 0 891 121 A1 and EP 1 029 909 A1. Hexaazatriphenylene derivatives are also useful HIL materials, as described in U.S. Pat. No. 6,720,573.

Another class of suitable materials for use in the HIL includes p-type doped organic materials. A p-type doped organic material typically includes a hole-transporting material such as an aromatic amine (see below) that is doped with an electron-accepting dopant. Such dopants can include, for example, 2,3,5,6-tetrafluoro-7,7,8,8-tetracyanoquinodimethane (F4-TCNQ) and other derivatives of 7,7,8,8-tetracyanoquinodimethane (TCNQ), and inorganic oxidizing agents such as iodine, FeCl3, FeF3, SbCl5, some other metal chlorides, and some other metal fluorides. The p-type doped concentration is preferably in the range of 0.01-20 vol. %. Such layers materials are further described in, for example, U.S. Pat. Nos. 5,093,698; 6,423,429, and 6,597,012.

Hole-Transporting Layer (HTL)

The hole-transporting layer 120 contains at least one hole-transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. in U.S. Pat. No. 3,180,730. Other suitable triarylamines substituted with one or more vinyl radicals and/or comprising at least one active hydrogen containing group are disclosed by Brantley et al U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. The hole-transporting layer can be formed of a single or a mixture of aromatic tertiary amine compounds. Illustrative of useful aromatic tertiary amines are the following:
1,1-Bis(4-di-p-tolylaminophenyl)cyclohexane
1,1-Bis(4-di-p-tolylaminophenyl)-4-phenylcyclohexane
N,N,N′,N′-tetraphenyl-4,4′″-diamino-1,1′:4′,1″:4″,1′″-quaterphenyl
Bis(4-dimethylamino-2-methylphenyl)phenylmethane
1,4-bis[2-[4-[N,N-di(p-tolyl)amino]phenyl]vinyl]benzene (BDTAPVB)
N,N,N′,N′-Tetra-p-tolyl-4,4′-diaminobiphenyl
N,N,N′,N′-Tetraphenyl-4,4′-diaminobiphenyl
N,N,N′,N′-tetra-1-naphthyl-4,4′-diaminobiphenyl
N,N,N′,N′-tetra-2-naphthyl-4,4′-diaminobiphenyl
N-Phenylcarbazole
4,4′-Bis[N-(1-naphthyl)-N-phenylamino]biphenyl (NPB)
4,4′-Bis[N-(1-naphthyl)-N-(2-naphthyl)amino]biphenyl (TNB)
4,4′-Bis[N-(1-naphthyl)-N-phenylamino]p-terphenyl
4,4′-Bis[N-(2-naphthyl)-N-phenylamino]biphenyl 4,4′-Bis[N-(3-acenaphthenyl)-N-phenylamino]biphenyl
1,5-Bis[N-(1-naphthyl)-N-phenylamino]naphthalene
4,4′-Bis[N-(9-anthryl)-N-phenylamino]biphenyl
4,4′-Bis[N-(1-anthryl)-N-phenylamino]-p-terphenyl
4,4′-Bis[N-(2-phenanthryl)-N-phenylamino]biphenyl
4,4′-Bis[N-(8-fluoranthenyl)-N-phenylamino]biphenyl
4,4′-Bis[N-(2-pyrenyl)-N-phenylamino]biphenyl
4,4′-Bis[N-(2-naphthacenyl)-N-phenylamino]biphenyl
4,4′-Bis[N-(2-perylenyl)-N-phenylamino]biphenyl
4,4′-Bis[N-(1-coronenyl)-N-phenylamino]biphenyl
2,6-Bis(di-p-tolylamino)naphthalene
2,6-Bis[di-(1-naphthyl)amino]naphthalene
2,6-Bis[N-(1-naphthyl)-N-(2-naphthyl)amino]naphthalene
N,N,N′,N′-Tetra(2-naphthyl)-4,4″-diamino-p-terphenyl
4,4′-Bis {N-phenyl-N-[4-(1-naphthyl)-phenyl]amino}biphenyl
2,6-Bis[N,N-di(2-naphthyl)amino]fluorene
4,4′,4″-tris[(3-methylphenyl)phenylamino]triphenylamine (MTDATA)
4,4′-Bis[N-(3-methylphenyl)-N-phenylamino]biphenyl (TPD)

Another class of useful hole-transporting materials includes polycyclic aromatic compounds as described in EP 1 009 041. Some hole-injecting materials described in EP 0 891 121 A1 and EP 1 029 909 A1 can also make useful hole-transporting materials. In addition, polymeric hole-transporting materials can be used including poly(N-vinylcarbazole) (PVK), polythiophenes, polypyrrole, polyaniline, and copolymers including poly(3,4-ethylenedioxythiophene)/poly(4-styrenesulfonate) also called PEDOT/PSS.

Light-Emitting Layer (LEL)

As more fully described in U.S. Pat. Nos. 4,769,292 and 5,935,721, one or more light-emitting layers (LEL) 130 of the organic EL element include a luminescent fluorescent or phosphorescent material where electroluminescence is produced as a result of electron-hole pair recombination in this region. The light-emitting layer can include a single material, but more commonly includes a host material doped with a guest emitting material or materials where light emission comes primarily from the emitting materials and can be of any color. This guest emitting material is often referred to as a light-emitting dopant. The host materials in the light-emitting layer can be an electron-transporting material, as defined below, a hole-transporting material, as defined above, or another material or combination of materials that support hole-electron recombination. The emitting material is usually chosen from highly fluorescent dyes and phosphorescent compounds, e.g., transition metal complexes as described in WO 98/55561, WO 00/18851, WO 00/57676, and WO 00/70655. Emitting materials are typically incorporated at 0.01 to 10% by weight of the host material.

The host and emitting materials can be small non-polymeric molecules or polymeric materials including polyfluorenes and polyvinylarylenes (e.g., poly(p-phenylenevinylene), PPV). In the case of polymers, small molecule emitting materials can be molecularly dispersed into a polymeric host, or the emitting materials can be added by copolymerizing a minor constituent into a host polymer.

An important relationship for choosing an emitting material is a comparison of the bandgap potential which is defined as the energy difference between the highest occupied molecular orbital and the lowest unoccupied molecular orbital of the molecule. For efficient energy transfer from the host to the emitting material, a necessary condition is that the band gap of the dopant is smaller than that of the host material. For phosphorescent emitters (including materials that emit from a triplet excited state, i.e., so-called “triplet emitters”) it is also important that the host triplet energy level of the host be high enough to enable energy transfer from host to emitting material. Host and emitting materials known to be of use include, but are not limited to, those disclosed in U.S. Pat. No. 4,768,292, U.S. Pat. No. 5,141,671, U.S. Pat. No. 5,150,006, U.S. Pat. No. 5,151,629, U.S. Pat. No. 5,405,709, U.S. Pat. No. 5,484,922, U.S. Pat. No. 5,593,788, U.S. Pat. No. 5,645,948, U.S. Pat. No. 5,683,823, U.S. Pat. No. 5,755,999, U.S. Pat. No. 5,928,802, U.S. Pat. No. 5,935,720, U.S. Pat. No. 5,935,721, U.S. Pat. No. 6,020,078, U.S. Pat. No. 6,475,648, U.S. Pat. No. 6,534,199, U.S. Pat. No. 6,661,023, US 2002/0127427 A1, US 2003/0198829 A1, US 2003/0203234 A1, US 2003/0224202 A1, US 2004/0001969 A1.

Metal complexes of 8-hydroxyquinoline (oxine) and similar derivatives constitute one class of useful host compounds capable of supporting electroluminescence. Illustrative of useful chelated oxinoid compounds are the following:
CO-1: Aluminum trisoxine [alias, tris(8-quinolinolato)aluminum(III)]
CO-2: Magnesium bisoxine [alias, bis(8-quinolinolato)magnesium(II)]
CO-3: Bis[benzo{f}-8-quinolinolato]zinc (II)
CO-4: Bis(2-methyl-8-quinolinolato)aluminum(III)-m-oxo-bis(2-methyl-8-quinolinolato) aluminum(III)
CO-5: Indium trisoxine [alias, tris(8-quinolinolato)indium]
CO-6: Aluminum tris(5-methyloxine) [alias, tris(5-methyl-8-quinolinolato)
aluminum(III)]
CO-7: Lithium oxine [alias, (8-quinolinolato)lithium(I)]
CO-8: Gallium oxine [alias, tris(8-quinolinolato)gallium(III)]
CO-9: Zirconium oxine [alias, tetra(8-quinolinolato)zirconium(IV)]

Another class of useful host materials includes derivatives of anthracene, such as those described in U.S. Pat. No. 5,935,721, U.S. Pat. No. 5,972,247, U.S. Pat. No. 6,465,115, U.S. Pat. No. 6,534,199, U.S. Pat. No. 6,713,192, US 2002/0048687, US 2003/0072966 and WO 2004/018587. Some examples include derivatives of 9,10-dinaphthylanthracene derivatives and 9-naphthyl-10-phenylanthracene. Other useful classes of host materials include distyrylarylene derivatives as described in U.S. Pat. No. 5,121,029, and benzazole derivatives, for example, 2,2′, 2″-(1,3,5-phenylene)tris[1-phenyl-1H-benzimidazole].

Desirable host materials are capable of forming a continuous film. The light-emitting layer can contain more than one host material in order to improve the device's film morphology, electrical properties, light emission efficiency, and lifetime. Mixtures of electron-transporting and hole-transporting materials are known as useful hosts. In addition, mixtures of the above listed host materials with hole-transporting or electron-transporting materials can make suitable hosts.

Useful fluorescent dopants include, but are not limited to, derivatives of anthracene, tetracene, xanthene, perylene, rubrene, coumarin, rhodamine, quinacridone, dicyanomethylenepyran compounds, thiopyran compounds, polymethine compounds, pyrylium and thiapyryilium compounds, fluorene derivatives, periflanthene derivatives, indenoperylene derivatives, bis(azinyl)amine boron compounds, bis(azinyl)methane boron compounds, derivatives of distryrylbenzene and distyrylbiphenyl, and carbostyryl compounds. Among derivatives of distyrylbenzene, particularly useful are those substituted with diarylamino groups, informally known as distyrylamines.

Suitable host materials for phosphorescent emitters (including materials that emit from a triplet excited state, i.e., so-called “triplet emitters”) should be selected so that the triplet exciton can be transferred efficiently from the host material to the phosphorescent material. For this transfer to occur, it is a highly desirable condition that the excited state energy of the phosphorescent material be lower than the difference in energy between the lowest triplet state and the ground state of the host. However, the band gap of the host should not be chosen so large as to cause an unacceptable increase in the drive voltage of the OLED. Suitable host materials are described in WO 00/70655 A2; 01/39234 A2; 01/93642 A1; 02/074015 A2; 02/15645 A1, and US 2002/0117662. Suitable hosts include certain aryl amines, triazoles, indoles and carbazole compounds. Examples of desirable hosts are 4,4′-N,N′-dicarbazole-biphenyl (CBP), 2,2′-dimethyl-4,4′-N,N′-dicarbazole-biphenyl, m-(N,N′-dicarbazole)benzene, and poly(N-vinylcarbazole), including their derivatives.

Examples of useful phosphorescent materials that can be used in light-emitting layers of this invention include, but are not limited to, those described in WO 00/57676, WO 00/70655, WO 01/41512 A1, WO 02/15645 A1, US 2003/0017361 A1, WO 01/93642 A1, WO 01/39234 A2, U.S. Pat. No. 6,458,475 B1, WO 02/071813 A1, U.S. Pat. No. 6,573,651 B2, US 2002/0197511 A1, WO 02/074015 A2, U.S. Pat. No. 6,451,455 B1, US 2003/0072964 A1, US 2003/0068528 A1, U.S. Pat. No. 6,413,656 B1, U.S. Pat. No. 6,515,298 B2, U.S. Pat. No. 6,451,415 B1, U.S. Pat. No. 6,097,147, US 2003/0124381 A1, US 2003/0059646 A1, US 2003/0054198 A1, EP 1 239 526 A2, EP 1 238 981 A2, EP 1 244 155 A2, US 2002/0100906 A1, US 2003/0068526 A1, US 2003/0068535 A1, JP 2003/073387 A, JP 2003/073388 A, US 2003/0141809 A1, US 2003/0040627 A1, JP 2003/059667 A, JP 2003/073665 A, and US 2002/0121638 A1.

Electron-Transporting Layer (ETL)

Useful thin film-forming materials for use in forming the electron-transporting layer 140 of the organic EL elements of this invention are metal chelated oxinoid compounds, including chelates of oxine itself (also commonly referred to as 8-quinolinol or 8-hydroxyquinoline). Such compounds help to inject and transport electrons, exhibit high levels of performance, and are readily fabricated in the form of thin films. Exemplary oxinoid compounds were listed previously.

Other electron-transporting materials include various butadiene derivatives as disclosed in U.S. Pat. No. 4,356,429 and various heterocyclic optical brighteners as described in U.S. Pat. No. 4,539,507. Benzazoles, oxadiazoles, triazoles, pyridinethiadiazoles, triazines, phenanthroline derivatives, and some silole derivatives are also useful electron-transporting materials.

Electron-Injecting Layer (EIL)

To obtain low driving voltage, an n-type doped organic material can be used to form an electron-injecting layer (EIL) disposed adjacent to the cathode. The EIL can be disposed between an ETL and the cathode, or it can also serve the function of the ETL. An n-type doped organic material typically contains an organic electron-transporting material (see above) and an electron-donating dopant such as low work-function metal (<4.0 eV). See, for example, U.S. Pat. Nos. 5,458,977; 6,013,384; 6,509,109 and 6,639,357. Particularly useful electron-transporting materials for use in the EIL include metal chelated oxinoid compounds such as Alq and phenanthroline derivatives. Other useful materials include butadiene derivative, triazines, benzazole derivatives, and silole derivatives. In some instances it is useful to combine two or more hosts to obtain the proper charge injection and stability properties.

Suitable metals for the metal-doped organic layer include alkali metals (e.g. lithium, sodium), alkaline earth metals (e.g. barium, magnesium), metals from the lanthanide group (e.g. lanthanum, neodymium, lutetium), or combinations thereof. The concentration of the low work-function metal in the metal-doped organic layer is in the range of from 0.1% to 30% by volume. Preferably, the concentration of the low work-function metal in the metal-doped organic layer is in the range of from 0.2% to 10% by volume. Conveniently, the low work-function metal is provided in a mole ratio of about 1:1 with the organic electron transporting material.

Cathode

When the cathode includes bottom electrodes 110 and light emission is viewed solely through the anode, the cathode used in this invention can include nearly any conductive material. Desirable materials have good film-forming properties to ensure good contact with the underlying organic layer, promote electron injection at low voltage, and have good stability. Useful cathode materials often include a low work function metal (<4.0 eV) or metal alloy. One preferred cathode material includes a Mg:Ag alloy wherein the percentage of silver is in the range of 1 to 20%, as described in U.S. Pat. No. 4,885,221. Another suitable class of cathode materials includes bilayers comprising a thin electron-injection layer (EIL) in contact with the organic layer (e.g., ETL) which is capped with a thicker layer of a conductive metal. Here, the EIL preferably includes a low work function metal or metal salt, and if so, the thicker capping layer does not need to have a low work function. One such cathode includes a thin layer of LiF followed by a thicker layer of Al as described in U.S. Pat. No. 5,677,572. Other useful cathode material sets include, but are not limited to, those disclosed in U.S. Pat. Nos. 5,059,861; 5,059,862; and 6,140,763.

When the cathode is common light-transmissive electrode 150 and light emission is viewed through the cathode, the cathode should be as transparent as possible. For such applications, metals must be thin or one must use transparent conductive oxides, or a combination of these materials. The most common materials used for the electrode are indium tin oxide (ITO), indium zinc oxide (IZO), or a thin metal layer such as Al, Mg, or Ag which is preferably between 5 nm and 20 nm in thickness. If used, such thin metals would typically be coated with a thicker layer of a conductive oxide such as ITO or IZO. Optically transparent cathodes have been described in more detail in U.S. Pat. No. 4,885,211, U.S. Pat. No. 5,247,190, U.S. Pat. No. 5,703,436, U.S. Pat. No. 5,608,287, U.S. Pat. No. 5,837,391, U.S. Pat. No. 5,677,572, U.S. Pat. No. 5,776,622, U.S. Pat. No. 5,776,623, U.S. Pat. No. 5,714,838, U.S. Pat. No. 5,969,474, U.S. Pat. No. 5,739,545, U.S. Pat. No. 5,981,306, U.S. Pat. No. 6,137,223, U.S. Pat. No. 6,140,763, U.S. Pat. No. 6,172,459, EP 1 076 368, U.S. Pat. No. 6,278,236, and U.S. Pat. No. 6,284,393. Cathode materials are typically deposited by evaporation, sputtering, or chemical vapor deposition. When needed, patterning can be achieved through many well known methods including, but not limited to, through-mask deposition, integral shadow masking, for example, as described in U.S. Pat. No. 5,276,380 and EP 0 732 868, laser ablation, and selective chemical vapor deposition.

Other Common Organic Layers and Device Architecture

In some instances, light-emitting layer 130 and electron-transporting layer 140 can optionally be collapsed into a single layer that serves the function of supporting both light emission and electron transportation. It also known in the art that emitting dopants can be added to the hole-transporting layer, which can serve as a host. Multiple dopants can be added to one or more layers in order to create a white-emitting OLED, for example, by combining blue- and yellow-emitting materials, cyan- and red-emitting materials, or red-, green-, and blue-emitting materials. White-emitting devices are described, for example, in EP 1 187 235, EP 1 182 244, U.S. Pat. No. 5,683,823, U.S. Pat. No. 5,503,910, U.S. Pat. No. 5,405,709, U.S. Pat. No. 5,283,132, US 2002/0186214, US 2002/0025419, US 2004/0009367, and U.S. Pat. No. 6,627,333.

Additional layers such as exciton-, electron-, and hole-blocking layers as taught in the art can be employed in devices of this invention. Hole-blocking layers are commonly used to improve efficiency of phosphorescent emitter devices, for example, as in US 2002/0015859, WO 00/70655A2, WO 01/93642A1, US 2003/0068528 and US 2003/0175553 A1.

This invention can be used in a so-called tandem device architecture, for example, as taught in U.S. Pat. No. 6,337,492, US 2003/0170491, and U.S. Pat. No. 6,717,358. Such tandem devices have multiple electroluminescent units provided between an anode and a cathode, usually with connector layer between units to promote charge generation and injection into the electroluminescent units.

Deposition of Organic Layers

The organic materials mentioned above are suitably deposited through a vapor-phase method such as sublimation, but can be deposited from a fluid, for example, from a solvent with an optional binder to improve film formation. If the material is a polymer, solvent deposition is useful but other methods can be used, such as sputtering or thermal transfer from a donor sheet. The material to be deposited by sublimation can be vaporized from a sublimation “boat” often includes a tantalum material, e.g., as described in U.S. Pat. No. 6,237,529, or can be first coated onto a donor sheet and then sublimed in closer proximity to the substrate. Layers with a mixture of materials can utilize separate sublimation boats or the materials can be pre-mixed and coated from a single boat or donor sheet. Patterned deposition can be achieved using shadow masks, integral shadow masks (U.S. Pat. No. 5,294,870), spatially-defined thermal dye transfer from a donor sheet (U.S. Pat. Nos. 5,688,551; 5,851,709 and 6,066,357) and inkjet method (U.S. Pat. No. 6,066,357).

Encapsulation

Most OLED devices are sensitive to moisture or oxygen, or both, so they are commonly sealed in an inert atmosphere such as nitrogen or argon. In sealing an OLED device in an inert environment, a protective cover can be attached using an organic adhesive, a metal solder, or a low-melting-temperature glass. In this invention, the protective cover can be made from glass, polymeric films, composite materials, or others as long as it is sufficiently light transmissive. Commonly, a getter or desiccant is also provided within the sealed space. Useful getters and desiccants include, alkali and alkaline metals, alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOx, aluminum oxide, paralene, Teflon, and alternating inorganic/polymeric layers are known in the art for encapsulation. In a preferred embodiment, aluminum oxide is deposited by atomic layer deposition, as is known in the art. Such barrier layer(s) can be provided after forming patterned conductive layer structure 20 but before providing optical material 190 into the wells; that is, a barrier layer is formed over e.g. common light-transmissive electrode 150 and patterned conductive layer structure 20. Alternatively, or in addition, barrier layers can be provided over the optical materials and the patterned conductive layer structure, that is, after deposition of the optical material. Before depositing barrier layers, it is advisable to ensure that any solvents or moisture trapped in the conductive layer structure or optical material has been removed, e.g., by thermal processing.

Optical Optimization

OLED devices of this invention can employ various well-known optical effects in combination with optical materials deposited in one or more wells in order to enhance its properties if desired. This includes optimizing layer thicknesses to yield maximum light transmission, providing dielectric mirror structures, replacing reflective electrodes with light-absorbing electrodes, providing anti glare or anti-reflection coatings over the display, providing a polarizing medium over the display, or providing colored, neutral density, or color conversion filters in functional relationship with the light emitting areas of the display. Filters, polarizers, and anti-glare or anti-reflection coatings can also be provided over a cover or as part of a cover.

The OLED device can have a microcavity structure. In one useful example, one of the metallic electrodes is essentially opaque and reflective; the other one is reflective and semitransparent. The reflective electrode is preferably selected from Au, Ag, Mg, Ca, or alloys thereof. Because of the presence of the two reflecting metal electrodes, the device has a microcavity structure. The strong optical interference in this structure results in a resonance condition. Emission near the resonance wavelength is enhanced and emission away from the resonance wavelength is depressed. The optical path length can be tuned by selecting the thickness of the organic layers or by placing a transparent optical spacer between the electrodes. For example, an OLED device of this invention can have ITO spacer layer placed between a reflective anode and the organic EL media, with a semitransparent cathode over the organic EL media.

This invention can also be applied to inverted OLED structures wherein the cathode is on substrate and the anode is on the top of the device.

The invention has been described in detail with particular reference to certain preferred embodiments thereof, but it will be understood that variations and modifications can be effected within the spirit and scope of the invention.

### Parts List

10 OLED display
20 patterned conductive layer structure
25 patterned conductive layer structure
30 OLED device
30a OLED device
30b OLED device
30c OLED device
30d OLED device
40 cross-section line
50 OLED display
60 well
70 inter-OLED-device area
100 substrate
110 bottom electrode
120 hole-transporting layer
130 light-emitting layer
140 electron-transporting layer
150 common light-transmissive electrode
160 patterned conductive layer
170 patterned insulating layer
180 well
190 optical material
200 block
210 block
220 block
225 block
230 block
235 block
240 block
250 block
260 block
270 block
300 OLED display
310 light-scattering material
320 light-transmissive cover
330 gap

1. A method of making an OLED display having a plurality of OLED devices comprising:
(a) providing a plurality of OLED devices on a substrate, such OLED devices sharing a common light-transmissive electrode;
(b) forming a patterned conductive layer structure over the common light-transmissive electrode to define wells in alignment with emissive areas of one or more OLED devices; and
(c) providing optical material into one or more wells.

2. The method according to claim 1 wherein the patterned conductive layer structure includes a patterned conductive layer in contact with the common light-transmissive electrode and a patterned insulating layer disposed over the patterned conductive layer.

3. The method according to claim 2 wherein the patterned conductive layer structure is formed by:
(i) depositing a conductive layer over the common light-transmissive electrode;
(ii) providing a patterned insulating layer over the conductive layer; and
(iii) using the patterned insulating layer as an etch mask to pattern the conductive layer to form the patterned conductive layer.

4. The method according to claim 3 wherein the patterned insulating layer is provided by uniformly coating a polymer layer and using laser ablation to pattern the polymer layer.

5. The method according to claim 3 wherein the patterned insulating layer is provided by patterned thermal transfer of a polymer from a donor sheet.

6. The method according to claim 3 wherein the conductive layer is patterned by chemical etching or plasma etching.

7. The method according to claim 1 wherein the optical material is provided into the one or more wells by ink jet deposition.

8. The method according to claim 1 wherein the optical material is a color filter material, a color conversion material, a light-scattering material, or a lenslet.

9. The method according to claim 8 wherein different color filter materials are deposited into different wells by ink jet deposition to provide a color filter array.

10. The method according to claim 9 wherein the optical materials do not fill the well and the wells serve as barriers to prevent the diffusion of optical material from one well to another.

11. The method according to claim 1 wherein the patterned conductive layer structure acts as a black matrix.

12. The method according to claim 1 wherein one or more barrier layers are provided after forming the patterned conductive layer structure but before providing optical materials into the one or more wells.

13. The method according to claim 1 further comprising:
(d) providing one or more barrier layers over the optical material and the patterned conductive layer structure.

14. The method according to claim 1 wherein a light-transmissive cover is provided over the display.

15. The method according to claim 8 wherein the optical material includes a light scattering material, a light-transmissive cover is provided over the display and there is a gap of at least 0.5 microns between the light-scattering material and the cover, said gap is filled with air, inert gas, or a material having an optical refractive index lower than that of the light-transmissive cover and having an optical refractive index lower than that of any organic materials in the light-emissive layer(s) of the OLED.

16. The method according to claim 1 wherein the wells are greater than 0.5 microns deep.

17. The method according to claim 1 wherein the wells are greater than 5 microns deep.

18. The method according to claim 1 wherein the OLED display includes red, green, and blue, light-emitting pixels.

19. The method according to claim 18 further including white light-emitting pixels.

20. The method according to claim 1 wherein step (b) includes laser transfer of metal nanoparticles from a donor sheet to form the patterned conductive layer structure.
